(19) United States
(12) Patent Application Publication
(10) Pub. No.: US 2012/0169211 A1
(43) Pub. Date: Jul. 5, 2012

(54) LIGHTING DEVICE

(75) Inventors: Daniele Bortolato, Cappella die Scorze (VE) (IT); Maurizio Campobasso, Casier (TV) (IT); Daniele Nascimben, Silea (TV) (IT); Raffaele Piva, Treviso (IT)

(73) Assignee: OSRAM AG, Muenchen (DE)

(21) Appl. No.: 13/496,203

(22) PCT Filed: Sep. 17, 2010
(86) PCT No.: PCT/EP10/63683

§ 371 Date: Mar. 15, 2012

(30) Foreign Application Priority Data
Sep. 23, 2009 (IT) TO2009A000726

(51) Int. Cl. H01J 5/50

(52) U.S. Cl. 313/318.01

(57) ABSTRACT

A lighting device may include a lighting source, and an electric power supply circuit for said lighting source, said lighting source and said power supply circuit being separated by respective walls defining an air separation gap between them.

### Field of the invention

The present description relates to lighting devices.

The description is provided with particular regard to integrated lighting devices comprising a light source, such as a halogen lamp, and a corresponding power supply circuit, such as an electronic transformer.

### Background art

During the manufacture of integrated lighting devices of the type described it must be considered that the lighting source is intended to operate at fairly high temperatures (and, for this reason, is sometimes referred to as a “burner”). In particular halogen lamps operate at temperatures higher than 200° C. and therefore constitute an intense source of heat able to be diffused towards the surrounding environment by means of irradiation, conduction or convection.

On the other hand, the electric/electronic components which are included in the power supply circuit are intended to operate at lower temperatures (for example, in any case at temperatures less than 130° C.)

It is therefore desirable that the two parts of the device (high-temperature lighting source and low-temperature power supply circuit) should be separated in some way, i.e. insulated, without this affecting the overall dimensions of the lighting device. This applies, for example to certain integrated lighting devices comprising a halogen lamp and an electronic transformer which is to be provided with a general form very similar to, if not at least partially reminiscent of, the form of a conventional light bulb.

The most widely adopted solution hitherto is that of creating ventilation openings in the casing, namely lining some parts of the device with resin having the function of a heat-insulating barrier.

### OBJECT AND SUMMARY OF THE INVENTION

The inventors have noted that these conventional solutions, in addition to having a certain constructional complexity, are not devoid of a number of fundamental drawbacks.

For example, in the case of solutions which envisage the use of ventilation openings, it may be difficult to ensure the desired level of electrical insulation and/or guarantee that the “live” parts of the lighting device are inaccessible, as required by safety standards. Moreover, the openings may allow the penetration of dust inside the lighting device.

In addition to involving the use of additional parts and materials, with a consequent negative effect on the costs and the simplicity of the production process, the solutions which envisage the use of resins may result in increased weight (This being an important factor in aircraft applications) and/or may be subject to variations in performance over time both as regards the insulation properties and as regards the possible risk of evaporation of materials, such as to have a negative effect on the luminous flux. Moreover, at least in some applications, problems associated with mechanical stresses may arise, for example as a result of thermal expansion of the resin. Furthermore, some of the resins which are traditionally used as insulants are materials which may be classified—if not as pollutants—at least as materials which have a negative effect on the environment, for example because they cannot be recycled.

The present invention aims to provide a solution able to overcome the abovementioned drawbacks.

According to the present invention, this object is achieved by means of a device having the characteristic features indicated specifically in the claims below.

The claims form an integral part of the technical teaching provided here in relation to the invention.

Various embodiments are able to ensure suitable electrical insulation between the “live” parts of the lighting device, so that they are inaccessible, as required by safety standards. Moreover, the undesirable penetration of dust in such a way as to reduce in an undesirable manner the luminous flux is avoided.

Moreover, compared to the solutions which require the use of resins, various embodiments do not require additional high-temperature materials, resulting primarily in a different architecture of the device.

Various embodiments do not involve additional costs, either as regards the use of high-performance materials or as regards any additional process steps (the use of resin injection and production steps is, for example, avoided).

Various embodiments also avoid the weight increases and variations in performance due both to long-term chemical modifications and to the undesirable evaporation of materials likely to cause a reduction in the luminous flux, for example due to gas losses.

Various embodiments furthermore avoid the undesirable development of mechanical stresses in the components, in particular as regards heat expansion phenomena.

Finally, various embodiments solve any problem arising in connection with the use of “non-ecological” materials.

### BRIEF DESCRIPTION OF THE ACCOMPANYING DRAWINGS

The invention will now be described, purely by way of a non-limiting example with reference to the accompanying drawings in which:

FIG. 1 is a general, partially cut-away and cross-sectioned, perspective view of a lighting device according to an embodiment, and

FIGS. 2 and 4 show various constructional details of embodiments.

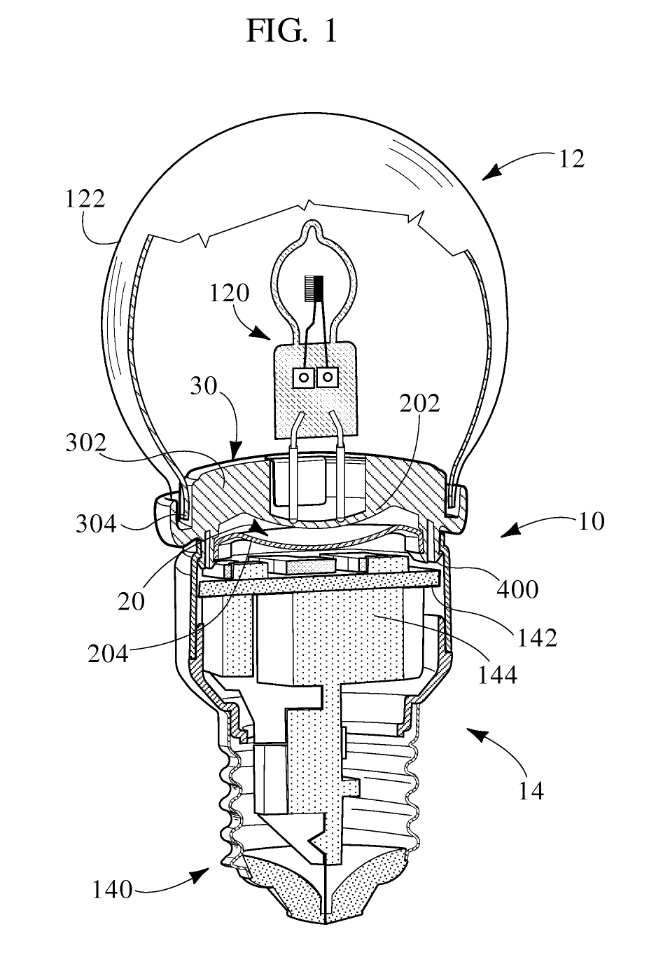

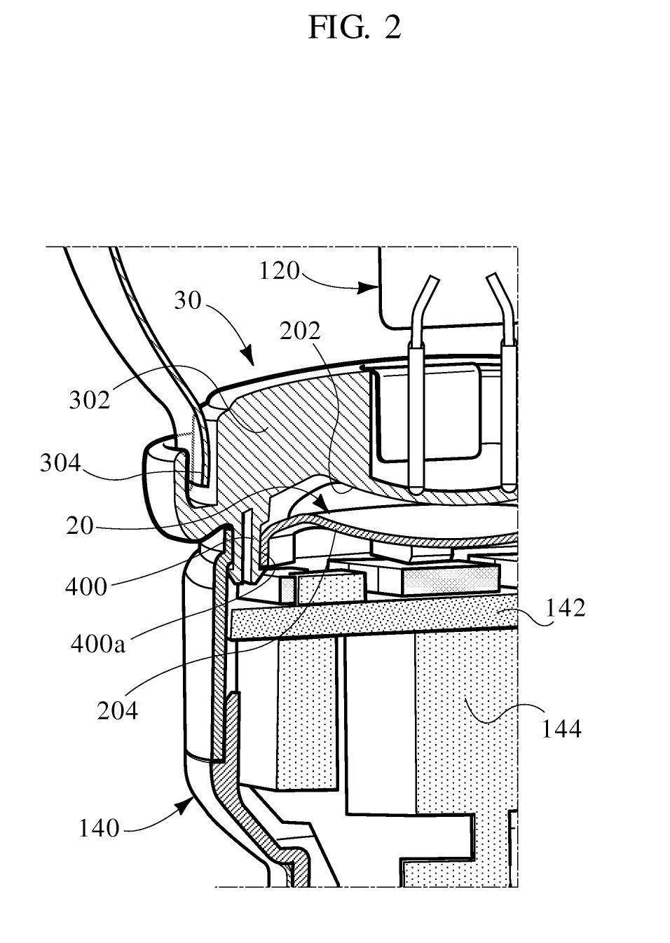

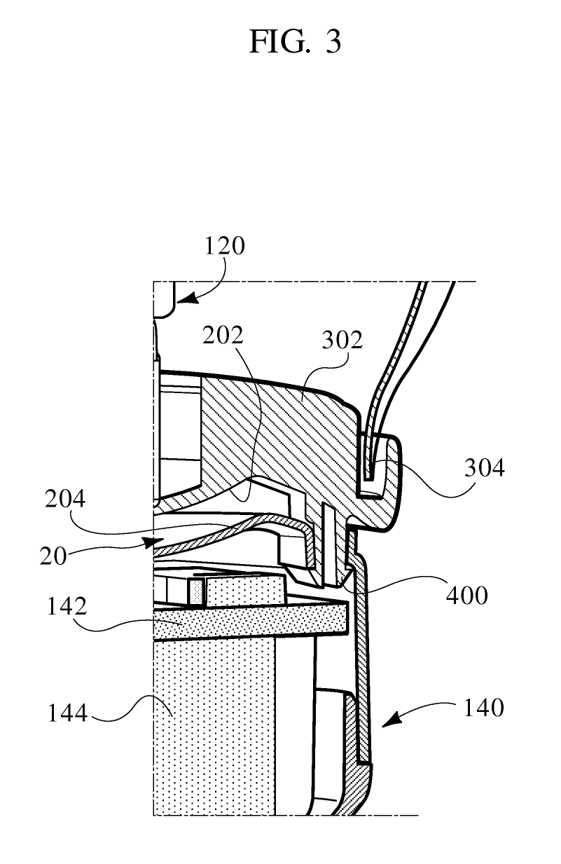

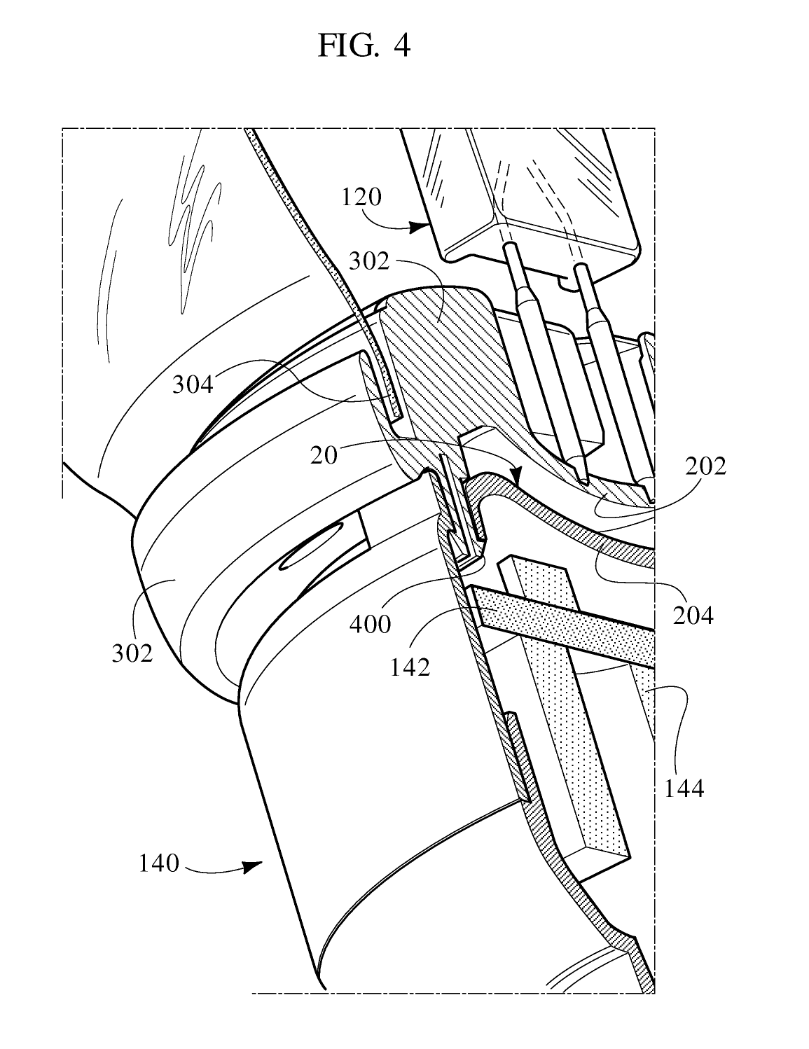

### DETAILED DESCRIPTION OF EMBODIMENTS

Various specific details aimed at allowing an in-depth understanding of the embodiments are illustrated in the description below. The embodiments may be implemented without one or more of the specific details, or using other methods, components, materials, etc. In other cases, known operations, materials or structures have not been illustrated or described in detail in order to avoid overshadowing various aspects of the embodiments.

The reference to “an embodiment” in connection with this description indicates that a particular configuration, structure or characteristic feature described in relation to the embodiment is included in at least one embodiment. Therefore, phrases such as “in one embodiment”, which may occur at different points in this description, do not necessarily refer to the same embodiment. Moreover, particular forms, structures or characteristic features may be combined in a suitable manner in one or more embodiments.

The reference numbers used here are intended only for convenience and therefore do not define the scope of protection or range embraced by the embodiments.

In the figures, the reference number 10 denotes in its entirety a lighting device which, in the embodiments considered here, has an overall appearance substantially comparable to the appearance of a conventional light bulb.

In relation to the device 10 the following may therefore be identified:

a part 12 which may be described generally as being a lighting source, and

a part 14 which may be described generally as being an (electric) power supply circuit for the lighting source.

Still with reference to the embodiment illustrated here by way of example, the light source 12 comprises an actual source of illumination (or “burner”) 120 consisting of a halogen lamp enclosed in turn inside a transparent protection bulb 122 with an overall spherical or generally bulb-like form.

The halogen lamp 120 may be of the so-called “tear drop” type already provided with a bulb or casing made of transparent material such as glass which encloses the actual lighting body intended to become incandescent and therefore a source of light radiation as a result of the electric current passing through it.

In the example of embodiment shown here, the power supply circuit 14, which is intended to produce this current, is inserted inside a casing 140 which overall is comparable to a Edison type fitting of a conventional light bulb. The casing 140 contains a PCB (printed circuit board) 142 on which the components 144 of the electric power supply circuit are mounted.

The specific description of the various parts provided above is intended as being purely an example of one possible embodiment. In various embodiments, the lighting source 12 and the power supply circuit 14 may have characteristics which are different from those illustrated here. To give an example, the electric circuit part 14, instead of being in the form of a threaded shank, may be in the form of a sliding-engagement or bayonet part.

Various embodiments considered here take into account the fact that the lighting source 12 (and in particular the burner 120) is intended to operate at very high temperatures (for example 200° C.), while in the case of the electric circuit 14, and in particular in the case of the components 144 mounted on the board 142, it is preferable to be able to operate at temperatures which are decidedly lower (for example 130° C. or less), at the same time, also taken into account is the fact that the high operating temperatures of the burner 120 are responsible for widespread propagation of heat from the burner 120 itself by means of irradiation, conduction or convection.

Various embodiments envisage that a separation gap or space 20 formed by air, and therefore a material which has excellent heat insulation properties, is present between the two parts of the lighting device 10 (i.e. between the lighting source 12 and the electric power supply circuit 14).

The air separation space 20 is defined between the facing surfaces of two walls 202, 204, the first one of which (wall 202) is directed towards the lighting source 12 and helps form with respect to the lighting source (burner 120) a heat-insulating shield made preferably of a material (for example plastic) having a high thermal resistance coefficient (low thermal conductivity).

For example, the wall 202 may form the bottom wall of a kind of cup-shaped dish, denoted overall by 30 and comprising a collar-like outer part, denoted by 302, provided with an annular peripheral groove 304. The groove 304, which surrounds the wall 202, receives the rim of the mouth of the bulb 122 which has a cup or bowl-like structure open downwards and therefore with an open bottom end.

In various embodiments, owing to its function of an ideal “complement” to the bulb 122, the wall 202 may preferably have a concave progression with its concavity directed towards the burner 120.

According to a generally complementary configuration, the wall 204 forms a kind of cover or lid which closes at the top the casing 140 inside which the components of the electric circuit 14 are situated. The wall 204 may have a concave progression which imitates in a complementary manner the concave progression of the wall 202 so as to give the air separation space 20 a thickness (or “height”) which is at least approximately constant over its entire extension.

The wall 204 may be made of a material (once again it may be a plastic) with heat resistance properties, and therefore also having the function of a heat shield, although with properties which are less critical than the properties of the wall 202. Precisely the presence of the air space or gap 20 is such that the wall 204 operates in any case at temperatures lower than those of the wall 202.

In order to ensure the structural connection between the two parts 12 and 14 of the device 10 it is possible to use formations substantially comparable to feet denoted by 400 and extending, for example in angularly equidistant positions (for example with an angular spacing of 120 or 90 degrees), along the contour of the walls 202 and 204.

For example, in the embodiment considered here, the formations 400 are present in the form of U-shaped lugs projecting from the collar part 302 and comprising two or more prongs provided with end teeth. These formations are intended to engage inside corresponding openings denoted by 400a and provided in the casing 140 along the contour of the wall 204.

This solution offers the advantages of creating, between the spring-like prongs of the formation 400, a space able to receive a flat electric contact intended to allow the connection between the electric circuit 14 and the lighting source 12 in the manner described more fully in a patent application for an industrial invention filed on the same date by the same present Applicants.

Various embodiments may adopt, in order to form the formations 400, solutions different from those illustrated here, allowing the presence of the air separation space denoted by 20 to be maintained. The criteria for achieving these alternative solutions are evident for the person skilled in the art and need not be described in greater detail here.

The fact that the formations 400 are present in a discontinuous manner along the periphery of the walls 202 and 204 results in the air gap or space 20 being in communication with the outside, which allows the creation of a ventilation mechanism inside the air space 20.

In the embodiments shown here, the propagation of heat from the burner 120 by means of irradiation towards the electric/electronic power supply circuits is greatly hindered (and in fact made impossible) owing to the simple fact that the burner 120 does not illuminate these circuits which are screened from the burner itself at least by the two walls 202 and 204.

The convection effects are greatly reduced in that the two surfaces represented by the walls 202, 204 are separated by the air gap 20, being moreover connected only by means of the formations 400. These conditions also reduce the heat conduction processes, also in view of the fact that, since the air gap 20 is in contact with the outside, the ventilation achieved as a result produces constant cooling of the formations 400.

Some possible constructional variants of the embodiments are described in two parallel patent applications filed on the same date by the same present Applicants.

Obviously, without altering the principle of the invention, the constructional details and the embodiments may vary, even significantly, from that illustrated here purely by way of a non-limiting example, without thereby departing from the scope of the invention, as defined by the accompanying claims.

1. A lighting device comprising:
a lighting source, and
an electric power supply circuit for said lighting source, said lighting source and said power supply circuit being separated by respective walls defining an air separation gap between them.

2. The device as claimed in claim 1,
wherein said walls have complementary shapes, so that said air separation gap has an at least approximately constant thickness.

3. The device as claimed in claim 1,
wherein said lighting source and said power supply circuit are mechanically connected together by localized formations extending across said air gap.

4. The device as claimed in claim 3,
wherein said formations are distributed along the periphery of said walls defining said air gap between them.

5. The device as claimed in claim 3,
wherein said formations have passageways for electrical contacts between said power supply circuit and said lighting source.

6. The device as claimed in claim 3,
wherein said formations are spring-like formations able to snap-engage inside corresponding receiving openings.

7. The device as claimed in claim 1,
wherein said air gap communicates with the outside of the lighting device so as to allow ventilation of the air gap.

8. The device as claimed in claim 1,
wherein at least one of said respective walls defining said air separation gap between them comprise a heat-insulating material.

9. The device as claimed in claim 1,
wherein said lighting source comprises a lighting body enclosed by a protection bulb having a mouth portion open towards said power supply circuit and wherein one of said respective walls defining an air separation gap is arranged so as to close the mouth portion of said protection bulb.

10. The device as claimed in claim 9,
wherein said one of said respective walls defining an air separation gap is surrounded by a peripheral groove for receiving the mouth portion of said protection bulb.

11. The device as claimed in claim 1,
wherein said power supply circuit is provided with a protection casing and in that one of said respective walls defining an air separation gap is arranged so as to close said protection casing.

12. The device as claimed in claim 2,
wherein said walls have complementary concave shapes.

13. The device as claimed in claim 8,
wherein both of said respective walls defining said air separation gap between them comprise a heat-insulating material.
